(19) United States
(12) Patent Application Publication
(10) Pub. No.: US 2007/0016506 A1
(43) Pub. Date: Jan. 18, 2007

(54) System and method for determining availability of a tradable instrument

(76) Inventors: James Davies, London (GB); Dan Eccleston, London (GB); Michael Sweeting, Aldershot (GB)

Correspondence Address: BAKER BOTTS L.L.P., 2001 ROSS AVENUE, SUITE 600, DALLAS, TX, 75201-2980, US

(21) Appl. No.: 11/133,746

(22) Filed: May 20, 2005

(51) Int. Cl. G06Q 40/00

(52) U.S. Cl. 705/37

(57) ABSTRACT

A method for initiating transactions of traded instruments includes determining an available offered quantity of a first instrument that represents an amount of the first instrument currently available to be purchased. The method also includes determining an unavailable offered quantity of the first instrument that represents an amount of the first instrument specified by a sale order associated with a first transaction. The method further includes determining a bid quantity specified by a purchase order associated with the first transaction and calculating a temporarily unavailable offered quantity of the first instrument based on a difference between the unavailable offered quantity of the first instrument and the bid quantity. Additionally, the method includes calculating a quantity of a second instrument based on a sum of the available offered quantity of the first instrument and at least a portion of

[symbol]

### TECHNICAL FIELD OF THE INVENTION

This invention relates in general to trading systems for financial instruments and, more particularly, to techniques for determining quantities of a financial instrument that are available for trading.

### BACKGROUND OF THE INVENTION

Investments having potential for large returns often involve some element of risk. Many techniques may be used to hedge against or otherwise manage risk associated with such investments. One such technique for reducing risk is through the diversification of investments. In theory, diversification of investments relies upon the law of averages to reduce risk associated with a particular transaction by spreading exposure to loss over multiple independent sources of risk.

As a result, spread transactions, which provide investment diversity by combining the value of two or more tradable instruments, have become useful tools for limiting exposure to risk. Thus, as financial markets have become more sophisticated the use of spreads has become commonplace, creating a need for techniques to effectively and profitably execute spreads.

### SUMMARY OF THE INVENTION

In connection with executing spreads, for example, it can be difficult to precisely determine the price at which a particular underlying instrument can be obtained, particularly where the spread involves a large number of underlying instruments. To ensure or maximize profitability, a market maker may choose not to execute a transaction involving a first instrument at a particular price if the market maker cannot guarantee being able to complete a second transaction involving a second instrument at another specified price.

As a result, a market participant choosing to respond conservatively to the imperfect market information available may unnecessarily terminate certain transactions based on inaccurate information regarding the availability of certain prices for the underlying instruments of the transaction. Alternatively, participants responding aggressively may find themselves completing transactions involving certain instruments based on mistaken expectations as to the availability of other instruments, resulting in losses for these participants. Thus, the ability to accurately predict the availability of instruments at various price levels in a market may enhance profitability for market participants executing spreads. In accordance with the present invention, these disadvantages and problems associated with investment trading systems have been substantially reduced or eliminated. In particular, a system and method are provided for initiating transactions based on a virtually available quantity of a tradable instrument.

In accordance with one embodiment of the present invention, a method for initiating transactions of traded instruments includes determining an available offered quantity of a first instrument that represents an amount of the first instrument currently available to be purchased in a market for the first instrument. The method also includes determining an unavailable offered quantity of the first instrument that represents an amount of the first instrument specified by a sale order associated with a first transaction involving the first instrument. The method further includes determining a bid quantity specified by a purchase order associated with the first transaction and calculating a temporarily unavailable offered quantity of the first instrument based on a difference between the unavailable offered quantity of the first instrument and the bid quantity. Additionally, the method includes calculating a quantity of a second instrument associated with a second transaction based, at least in part, on a sum of the available offered quantity of the first instrument and at least a portion of the temporarily unavailable offered quantity of the first instrument.

In accordance with another embodiment of the present invention, a method for initiating transactions of traded instruments includes determining an available bid quantity of a first instrument that represents an amount of the first instrument currently available bid for in a market for the first instrument. The method also includes determining an unavailable bid quantity of the first instrument that represents an amount of the first instrument specified by a purchase order associated with a first transaction involving the first instrument. The method further includes determining an offered quantity specified by a sale order associated with the first transaction and calculating a temporarily unavailable bid quantity of the first instrument based on a difference between the unavailable bid quantity of the first instrument and the offered quantity. Additionally, the method includes calculating a quantity of a second instrument associated with a second transaction based, at least in part, on a sum of the available bid quantity of the first instrument and at least a portion of the temporarily unavailable bid quantity of the first instrument.

Technical advantages of certain embodiments of the present invention include providing a more accurate assessment of the availability of financial instruments within financial markets for financial instruments. Other technical advantages of certain embodiments include the ability to initiate and terminate transactions involving a particular instrument based on a more accurate assessment of the availability of that instrument and to price transactions involving other instruments based on this assessment. Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a block diagram illustrating a trading system capable of executing orders for tradable instruments;

FIG. 2 illustrates an example operation of a particular embodiment of the trading system shown in FIG. 1;

FIG. 3 is a flowchart detailing operation of a particular embodiment of the trading system in completing an example transaction; and

FIG. 4 is a flowchart detailing operation of a particular embodiment of the trading system in completing another example transaction.

### DETAILED DESCRIPTION OF THE INVENTION

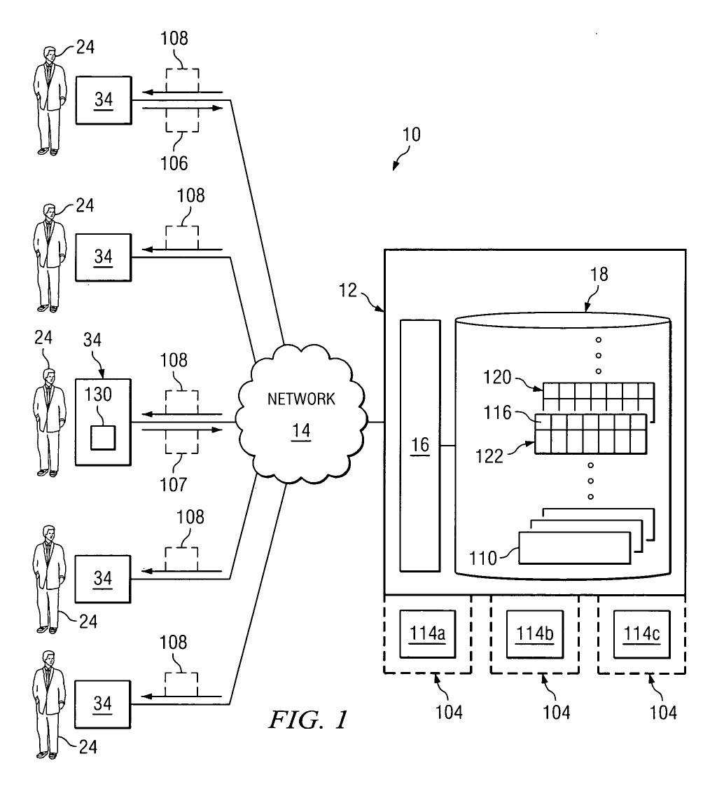

FIG. 1 illustrates a trading system 10 according to a particular embodiment of the present invention. In the illustrated embodiment, trading system 10 includes a trading platform 12 capable of receiving sale orders 106 and purchase orders 107 from participants 24 through participant interfaces 34 and of executing transactions in underlying markets 104 involving underlying instruments 114 based on these orders 106 and 107. In particular embodiments, participant interfaces 34 utilize certain techniques to determine the availability of underlying instruments 114 within the relevant underlying markets 104 to allow participants 24 to obtain optimal prices on particular underlying instruments 114 that are involved in spreads executed by participants 24. These techniques may, in turn, increase efficiency in trading as participants 24 are able to utilize more accurate information in making decisions associated with these trades. Although the description below focuses, for the purposes of illustration, on particular embodiments of trading system 10 that include particular elements configured in a particular manner, the present invention contemplates any trading systems capable of providing the described functionality using any appropriate elements configured in any suitable manner.

Trading platform 12 receives orders 106 and 107 from participants 24 for transactions involving underlying instruments 114 available in a particular underlying market 104, and execute transactions specified or described by such orders 106 and 107. For example, trading platform 12 may represent a server operated by a particular commodities exchange in which all of underlying instruments 114a-c are traded and trading platform 12 may be capable of executing trades in any of markets 104a-c. Although, in the illustrated embodiment, trading system 10 includes a single trading platform 12 that is associated with a plurality of underlying markets 104, alternative embodiments of trading system 10 may include multiple trading platforms 12 each associated with one or more underlying markets 104.

Additionally, for the purpose of this description and the claims that follow, trading platform 12 may execute transactions by directly performing the steps necessary to consummate the transaction and/or by communicating with other appropriate elements or entities to facilitate consummation of the transaction. As one example, in particular embodiments, trading platform 12 may maintain accounts for one or more participants 24 and may adjust these accounts in response to orders 106 and 107 received from the relevant participants 24. In embodiments in which trading system 10 spans multiple trading markets and includes multiple trading servers 12, each trading server 12 may maintain accounts for participants 24 trading in the markets associated with that trading server 12. Alternatively, trading platform 12 may communicate information associated with the received orders 106 and 107 to other elements of trading system 10 that maintain accounts for participants 24, such as an account server (not explicitly shown) associated with a particular market or markets.

Trading platform 12 may also maintain market information 108 specifying available prices and quantities, and/or other relevant information describing the current state of underlying markets 104. Trading platform 12 may provide this information to participants 24 to be used by these parties in making decisions related to the purchase and sale of instruments 114. In the illustrated embodiment, participants 24 interact with trading platform 12 using participant interfaces 34.

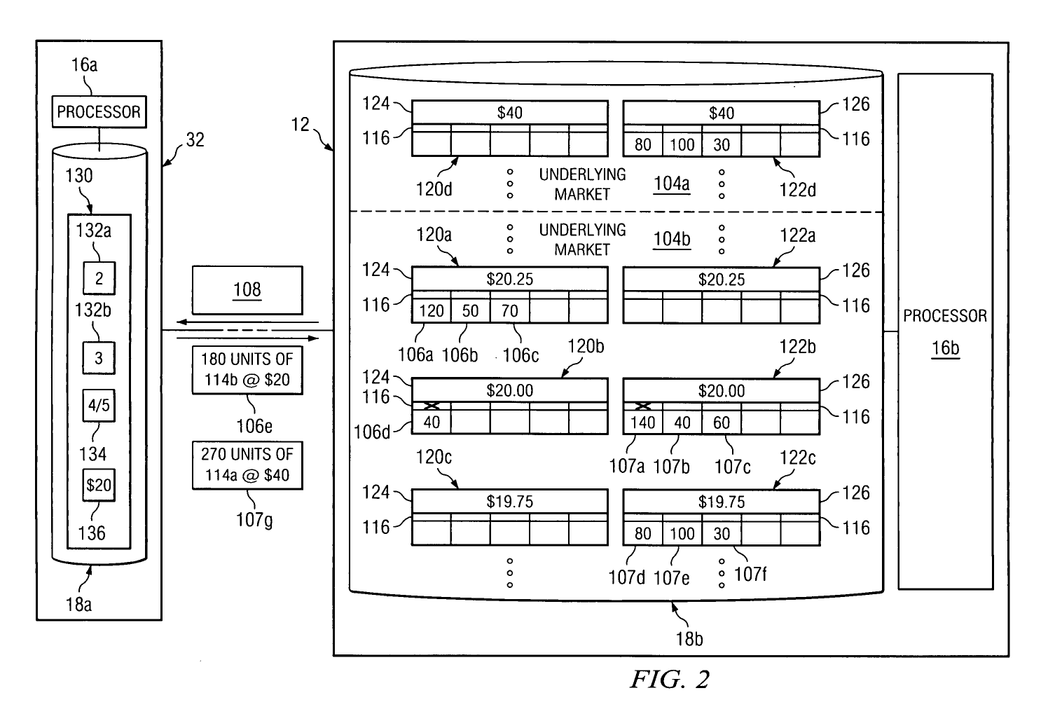

Trading platform 12 may represent any combination of software and/or hardware appropriate to provide the described functionality. As one example, trading platform 12 may represent a server operating in a computer network, such as the Internet, and participant interfaces 34 may represent personal computers (PCs) coupled to this computer network. Under such circumstances, trading platform 12 may be able to receive orders 106 and 107 as electronic mail, Hypertext Transfer Protocol (HTTP) requests, and/or any other appropriate form of electronic communication. As another example, trading platform 12 may represent an Automated Call Distributor (ACD) system capable of initiating telephonic communication sessions with participants 24 and receiving orders 106 and 107 as part of these telephone communication sessions. In the embodiment illustrated in FIG. 1, trading platform 12 includes a processor 16 and a memory 18. Although this description focuses, for the purposes of illustration, on embodiments of trading system 10 in which trading platform 12 represents a single, integrated component, in alternative embodiments, trading platform 12 may represent multiple, distributed components that are physically separated from one another. The contents and operation of an example embodiment of trading platform 12 are described in greater detail below with respect to FIG. 2.

Additionally, although the description below focuses on embodiments of trading system 10 in which trading platform 12 receives orders 106 and 107 and automatically executes transactions in response thereto, portions of this process may be performed manually in particular embodiments. For example, a participant 24 may initiate an order 106 by calling an operator associated with trading platform 12 and verbally communicating order 106 to the operator. The operator may then manually enter order 106 into trading platform 12. In general, trading platform 12 may receive, process, and execute purchase orders 107 and sale orders 106 associated with underlying instruments 114 in any appropriate manner based on the capabilities of trading platform 12 and the configuration of trading system 10.

Participant interfaces 34 facilitate interaction between trading platform 12 and participants 24. Participant interfaces 34 receive market information 108 from trading platform 12 and/or other components associated with underlying markets 104, and communicate this information to participants 24. Additionally, participant interfaces 34 receive input from participants 24 associated with orders 106 and 107 and transmit orders 106 and 107 to trading platform 12 and/or other components of trading system 10 for execution. Although FIG. 1 illustrates a particular embodiment of trading system 10 in which particular operations are performed and/or particular functionalities are provided by either participant 24 or participant interface 34, the described operations and functionalities may be divided between participant 24 and participant interface 34 in any appropriate manner. As a result, in particular embodiments, participants 24 may be absent from trading system 10 and fully-automated participant interfaces 34 may instead perform any operations completed by participant 24 in the following description.

Participant interfaces 34 may represent any appropriate combination of hardware and/or software, including multiple, physically-discrete components, to accept and transmit orders 106 and 107 placed by participants 24. As one example, participant interfaces 34 may represent personal computers (PCs) capable of receiving market information 108 from trading platform 12 and displaying market information 108 to participants 24. These PCs may also be capable of accepting orders 106 and 107 entered by participants 24 and transmitting orders 106 and 107 to trading platform 12. Moreover, although shown, for the sake of illustration, in FIG. 1 as coupling to trading platform 12 through network 14, participant interfaces 34 may communicate with trading platform 12, partly or entirely, independently from network 14. Thus, as another example, participant interfaces 34 may represent a television operable to receive and display market information 108 to participants 24 and a telephone through which participants 24 may communicate orders 106 and 107 to trading platform 12 or an operator of trading platform 12.

Underlying instruments 114 may include any financial instruments that are available to be traded in a market, such as, for example, securities (such as stocks or bond), options, futures contracts, currencies, or commodities, as well as tradable funds, such as index funds sector funds, or sub-sector funds. Underlying markets 104 represent markets for the trading of underlying instruments 114. Any two of underlying markets 104 may represent a common market, such as a stock or commodity exchange, in which multiple different types of underlying instruments 114 may be traded. Additionally, in particular embodiments, one or more of underlying instruments 114 may represent a spread instrument issued by and/or traded in a particular underlying market 104 whose value is based on the value of one or more other underlying instruments 114.

Spread order 130 includes information describing a spread that a particular participant 24 is attempting to execute. For the purposes of this description, a spread may represent any appropriate combination of trades in underlying instruments 114. As one example, executing a spread may involve acquiring a long position in a first underlying instrument 114 and a short position in a second underlying instrument 114. A particular spread may involve any appropriate number of underlying instruments 114 in any appropriate proportion. Spread order 130 may include information defining the composition of a requested spread, prices and/or price differentials at which the relevant underlying instruments 114 should be obtained, and/or any other appropriate information that may be used by participant interface 34 to complete the requested spreads. Spread orders 130 are transmitted to participant interfaces 34 by participants 24 (for example, by participants 24 manually entering spread orders 130 using a keyboard or other appropriate interface) and/or by other devices in communication system 10.

Participants 24 purchase and sell underlying instruments 114 in underlying markets 104. Participants 24 may represent any suitable traders, investors, speculators, brokers, or firms consisting of any combination of traders, investors, speculators, and/or brokers, or any other entities suitable to buy and sell underlying instruments 114 for the benefit of participants 24 or other third-party entities. Although in the illustrated embodiment only participant 24c is shown as executing spreads, any or all participants 24 may be capable of executing spreads and/or using the described techniques for determining the availability of underlying instruments 114.

In operation, participants 24 and/or participant interfaces 34 generate purchase orders 107 and sale orders 106 describing transactions to be executed by trading platform 12. Participant interfaces 34 then transmit these orders 106 and orders 107 to trading platform 12 to be executed. For example, in particular embodiments, participant interfaces 34 may transmit sale orders 106 requesting the sale of particular quantities of one or more underlying instruments 114. Sale orders 106 may specify a particular underlying instrument 114 and include an offered quantity and an offered price indicating, respectively, the quantity of the underlying instrument 114 the relevant party would like to sell and the price at which the party would like to sell. Similarly, in such embodiments, participant interfaces 34 may also transmit purchase orders 107 requesting the purchase of particular quantities of one or more underlying instruments 114. Purchase orders 107 may specify a particular underlying instrument 114 and include a bid quantity and a bid price indicating, respectively, the quantity of the underlying instrument 114 the relevant party would like to purchase and the price the party would like to pay.

Additionally, one or more of participant interfaces 34 receives spread orders 130 from a participant 24 (and/or another element of trading system 10) and may generate orders 106 and 107 based on the received spread orders 130. As noted above, spread orders 130 may describe spreads that a particular participant 24 is attempting to execute and may define prices, quantities, ratios, and/or other suitable information that participants interfaces 34 may use in generating the appropriate orders 106 and 107 to execute the spread. As part of executing the requested spread, participant interfaces 34 may initiate sale orders 106 and purchase orders 107 to initiate the underlying transactions associated with the spread.

Trading platform 12 receives orders 106 and 107 and executes transactions specified by them. In particular embodiments, trading platform 12 maintains trading accounts 110 associated with one or more of participants 24 that indicate quantities of various underlying instruments 114 owned by the relevant party and financial resources available to the relevant party for trading, such as an amount of money deposited in the account. In such embodiments, trading platform 12 may execute trades specified by orders 106 and 107, in part or in whole, by adjusting trading accounts 110 and/or information stored in or associated with trading accounts 110. In response to receiving orders 106 and 107, trading platform 12 may adjust the share totals and cash balances of trading accounts 110 associated with the relevant parties to reflect the requested transactions. In particular embodiments, trading platform 12 may additionally or alternatively communicate with other components of trading system 10 and/or components external to trading system 10 to complete the trade.

Trading platform 12 also generates market information 108 based, at least in part, on orders 106 and 107 received by trading platform 12. Market information 108 may specify available prices and quantities for particular underlying instruments 114, the contents of orders 106 or 107 received by trading platform 12, the identity of parties currently offering to sell or buy underlying instruments 114, the status of trades being executed in particular underlying markets 104, and/or any other relevant information describing the state of underlying markets 104 and/or characteristics or properties of underlying instruments 114. Trading platform 12 may then transmit market information 108 to participants 24 through participant interfaces 34, respectively. Participants 24 may in turn use market information 108 in making decisions regarding trades initiated by participants 24. For example, in executing a spread involving a first underlying instrument 114 and a second underlying instrument 114, participant 24 may utilize market information 108 that describes prices and availability for the first underlying instrument 114 to determine a price and quantity at which to sell the second underlying instrument 114.

When trading platform 12 receives an order 106 or 107 from participants 24 for a particular underlying instrument 114, in particular embodiments, trading platform 12 stores the order 106 or 107, a portion of the order 106 or 107, or information associated with order the 106 or 107 in memory 18 until the requested transaction can be executed. In particular embodiments, trading platform 12 maintains a plurality of sale queues 120 for each underlying instrument 114 with each sale queue 120 being associated with a particular offered price. When trading platform 12 receives sale orders 106, trading platform 12 identifies a sale queue 120 associated with both the underlying instrument 114 and the offered price specified by the received sale order 106 and places the received sale order 106 at the back end of the appropriate sale queue 120. Similarly, trading platform 12 may maintain a plurality of purchase queues 122 for each underlying instrument 114 with each purchase queue 122 associated with a particular bid price. When trading platform 12 receives a purchase order 107, trading platform 12 identifies a purchase queue 122 associated with the underlying instrument 114 and the bid price specified by the received purchase order 107 and places the received purchase order 107 at the back end of the appropriate purchase queue 122.

Trading platform 12 may also store in the relevant queue 120 or 122 information indicating an availability status of the order 106 or 107. The availability status of the order 106 or 107 indicates whether the order 106 or 107 may presently be used to satisfy orders in the corresponding queue 120 or 122 for the complementary transaction. For example, the availability status of a particular sale order 106 may reflect whether or not that sale order 106 is presently available to satisfy purchase orders 107 for the same underlying instrument 114 at the same price. Similarly, the availability status of a particular purchase order 107 may reflect whether or not that purchase order 107 is presently available to satisfy sale orders 106 for the same underlying instrument 114 at the same price.

Furthermore, the availability status of a particular order 106 or 107 may be affected by ongoing transactions, regulatory requirements, or any other suitable factors, criteria, and/or considerations. For example in the illustrated example, when trading platform 12 begins execution of a trade involving an order 106 or 107, that order 106 or 107 becomes unavailable until the transaction is completed. If a portion of the order 106 or 107 remains unfulfilled following completion of the transaction, the order 106 or 107 may be modified to reflect the unfulfilled quantity or a new order 106 or 107 may be generated specifying the unfulfilled quantity, and the modified or new order 106 or 107 may again become available following completion of the trade.

In the illustrated embodiment, the availability status of a particular order 106 or 107 is specified by an availability indicator 116 that is stored with order 106 or 107 in queue 120 or 122. The availability of orders 106 or 107 may be indicated and/or maintained by trading platform 12 in any appropriate manner. In particular embodiments, trading platform 12 may, by default, store orders 106 and 107 in the appropriate queue 120 or 122 with an availability indicator 116 indicating the availability status of the relevant order 106 or 107. As described below, trading platform 12 may update this availability indicator 116 while a transaction involving the associated order 106 or 107 is being executed and/or at any other appropriate time. Trading platform 12 may also transmit updated market information 108 or other information that reflects the change in the availability status of orders 106 and 107 in queues 120 or 122 to one or more of participant interfaces 34. As noted above, participants 24 may use this information to identify underlying instruments 114 to purchase or sell and/or prices at which to purchase or sell the relevant underlying instruments 114.

If trading platform 12 receives an order 106 or 107 specifying an underlying instrument 114 and trade price for which trading platform 12 possesses a complementary order 106 or 107 that is currently available and that specifies the same underlying instrument 114 and the same or a better transaction price, trading platform 12 may match the relevant sale order 106 and purchase order 107 and complete appropriate steps to execute the trade between the parties that sent the relevant orders 106 and 107. If trading platform 12 currently possesses multiple available orders 106 or 107 that satisfy the terms of a newly received order 106 or 107, trading platform 12 matches the newly received order 106 or 107 to the order 106 or 107 currently located at the front of the appropriate queue 120 or 122. For example, if trading platform 12 receives a sale order 106 for underlying instrument 114a at a particular offered price, trading platform 12 matches that sale order 106 to the first purchase order 107 in the purchase queue 122 for underlying instrument 114a associated with the highest bid price for which trading platform 12 currently holds purchase orders 107 (assuming the highest bid price for which trading platform 12 has received purchase orders 107 is greater than or equal to the offered price specified by the received sale order). Trading platform 12 may then execute a transaction based on the matched sale order 106 and purchase order 107. This process is described in greater detail below with respect to FIG. 2.

Additionally, because this process may take time, trading platform 12 may designate orders 106 and 107 associated with the trade unavailable while trading platform 12 completes appropriate computations and/or other operations associated with execution of the appropriate transaction. For example, in particular embodiments, the buyer that transmitted the purchase order 107 involved in the trade may have the first option to purchase any remaining units offered by sale order 106, if purchase order 107 does not fully satisfy sale order 106. Trading platform 12, in particular embodiments, may designate the quantity as unavailable by adjusting the availability indicator 116 for both the sale order 106 and purchase order 107 associated with the trade. If the trade satisfies both the sale order 106 and the purchase order 107, trading platform 12 removes the orders 106 and 107 from their respective queues 120 and 122. If the trade does not fully satisfy one of the orders 106 and 107, trading platform 12 may subtract the traded quantity from the quantity that was originally specified in that order 106 or 107 and update its availability indicator 116 to once again indicate that order 106 or 107 is available. As a result, a portion of the original order 106 or 107 may again become available for subsequent trades.

Consequently, while trading platform 12 is executing a transaction, participant 24 may mistakenly believe that the quantities specified by the orders 106 and 107 involved in the transaction have been removed from the relevant underlying market 104, despite the fact that any remaining quantity of sale order 106 or purchase order 107 that is not satisfied as a result of the transaction may ultimately become available again for subsequent trades. If participant 24 is basing a decision to purchase or sell a first underlying instrument 114 on whether participant 24 can also purchase or sell a particular quantity of a second underlying instrument 114, participant 24 may mistakenly choose to terminate or not to initiate the transaction of the first underlying instrument 114. Participant 24 may as a result forgo profit that may have been made on the combined transactions. Participant 24 may also modify other transactions to compensate for the fact that participant 24 believes that the requested position in the relevant underlying instrument 114 is not available at the requested price. For example, participant 24 may cancel an order 106 or 107 involving a second underlying instrument 114 as a result of determining that a first underlying instrument 114 is not currently available at a particular price level.

Thus, an inaccurate indication of availability may create a number of inefficiencies in underlying markets 104, particularly where participant 24 relies on automated trading tools to generate trades 106. Consequently, to provide more accurate information for participant 24 and/or participant interface 34 to use in decision-making, participant interface 34 may implement certain techniques to provide more accurate indications of availability within underlying markets 104. In particular embodiments, participant interface 34 compares the contents of sale queues 120 and corresponding purchase queues 122 and determines a virtually available quantity of one or more underlying instruments 114 based on the net difference between the quantities bid and offered by orders 106 and 107 in the relevant queues 120 and 122. This virtually available quantity may include the amount currently available to buyers or the amount currently requested from sellers in a particular market 104 and at least a portion of an amount that is temporarily unavailable for any appropriate reason.

More specifically, participant interface 34 compares the contents of sale queues 120 and associated purchase queues 122 and, in particular embodiments, determines the virtual availability of underlying instruments 114 based on the net difference between unavailable amounts in the appropriate queues 120 and 122. For example, to determine the virtual available quantity of underlying instrument 114a at a $20 per unit offered price, participant interface 34 may compare the contents of the sale queue 120 for underlying instrument 114a that is associated with the $20 offered price and the purchase queue 122 for underlying instrument 114a that is associated with the $20 bid price. If, for example, the relevant sale queue 120 includes an order 106 for 30 units with an availability indicator 116 indicating that the order is “unavailable” and the relevant purchase queue 122 includes an order 107 for 50 units that is marked “unavailable,” participant interface 34 determines that the difference, or a bid for 20 units, may become available again shortly in that purchase queue 122.

Participant 24 may then use this information in its trading decisions. As one example, if participant 24 is attempting to sell 20 or fewer units of underlying instrument 114a as one of multiple transactions involved in executing a particular spread, participant 24 may, as a result of the virtually available bid quantity, proceed with the other transactions with increased confidence that a bid for twenty shares will be available. Thus, particular embodiments of participant interface 34 may be capable of determining virtually available quantities that describe the current state of underlying markets 104 with greater accuracy. The enhanced accuracy may, in turn, result in improved decision-making on the part of participants 24 who utilize the market information 108. In particular, use of market information 108 may reduce or eliminate the unnecessary termination of orders by participants 24 based on inaccurate availability information. In this regard, particular embodiments of participant interface 34 may provide multiple operational benefits. Various embodiments of communication system 10, however, may exhibit some, none, or all of these benefits.

FIG. 2 illustrates an example operation of a particular embodiment of participant interface 34 and trading platform 12. More specifically, FIG. 2 illustrates operation of participant interface 34 and trading platform 12 as participant interface 34 determines a virtually available quantity of a particular underlying instrument 114 and initiates a plurality of trades based on this virtually available quantity. As noted above, participant interface 34 and trading platform 12 may each include any appropriate hardware and/or software suitable to provide the described functionality. In the illustrated embodiment, both participant interface 34 and trading platform 12 include a processor 16 and a memory 18.

Processors 16a and 16b (referred to generically as “processors 16” collectively and a “processor 16” singularly) are operable to execute instructions associated with the operation of participant interface 34 and trading platform 12, respectively. Processors 16 may represent any suitable devices capable of processing and/or communicating electronic information. Examples of processor 16 include, but are not limited to, application-specific integrated circuits (ASICs), field-programmable gate arrays (FPGAs), digital signal processors (DSPs) and any other suitable specific or general purpose processors.

Memories 18a and 18b (referred to generically as “memories 18” collectively or a “memory 18” singularly) store processor instructions and/or any other appropriate information used by participant interface 34 and trading platform 12 in operation. In particular embodiments, trading platform 12 maintains queues 120 and 122 in memory 18b as described above with respect to FIG. 1. Trading platform 12 may also store, in memory 18b, market information 108, orders 106 and 107, and/or any other suitable information used by trading platform 12 during operation. Meanwhile, in particular embodiments, participant interface 34 may store local copies (not shown) of queues 120 and 122 in memory 18a. Participant interface 34 may also store orders 106 or 107 to be transmitted to trading platform 12, market information 108 received from trading platform 12, and/or any other suitable information used by participant interface 34 during operation. Memories 18 may represent any collection and arrangement of volatile or non-volatile, local or remote devices suitable for storing data such as, for example, random access memory (RAM) devices, read only memory (ROM) devices, magnetic storage devices, optical storage devices, or any other suitable data storage devices.

In the illustrated example, participant 24 attempts to execute a particular spread described by spread order 130. For the purposes of this example, the spread is assumed to include a particular quantity of long positions in underlying instrument 114a and the value of a particular quantity of short positions in underlying instrument 114b. Participant 24, or another suitable party or element of trading system 10, stores spread order 130 in memory 18a of participant interface 34 that specifies the composition of the spread, target prices for underlying instruments 114a and 114b, account information for participant 24, and/or any other appropriate information used by participant interface 34 to initiate the described transactions. In particular, spread order 130 may includes trade ratio 132a, which specifies a particular quantity of the relevant position in underlying instrument 114a that is included in each unit of the example spread, and trade ratio 132b, which specifies a particular quantity of the relevant position in underlying instrument 114b that is included in each unit of the example spread. In the illustrated example, these trade ratios 132 indicate specifically that the value of each unit of the example spread is determined based on the value of three long positions in underlying instrument 114a and two short positions in underlying instrument 114b. Thus, in the illustrated example, participant 24 may purchase the example spread described by spread order 130 by purchasing two units of underlying instrument 114a and selling three units of underlying instrument 114b for every unit of the example spread requested by spread order 130.

Additionally, participant 24 may attempt to execute transactions involving one of the relevant underlying instruments 114 based on the current market prices available for the other underlying instrument 114, resulting in a predetermined price associated with executing the spread. For example, participant interface 34 may determine a price at which to purchase underlying instrument 114a based on a best available bid price 126 for underlying instrument 114b and a spread price 136 specified by spread order 130. In this example, participant interface 34 attempts to execute the requested spread at the specified spread price 136 of $20 per unit (notwithstanding any long position participant 24 acquires in underlying instrument 114a as a result of the relevant transactions or the obligation associated with any short position participant 24 undertakes in underlying instrument 114b). Consequently, participant 24 adjusts the bid price that participant 24 bids on underlying instrument 114a based on the best bid price 126 available to participant 24 for underlying instrument 114b in market 104b to ensure that the bid price 126 at which participant 24 is able to purchase two units of underlying instrument 114a is no greater than $20 more than the offered price 124 at which participant 24 is able to sell three units of underlying instrument 114b. For example, if participant 24 is able to sell underlying instruments 114b at $20 per unit, participant 24 will attempt to buy two units of underlying instrument 114a at a price of (3×$20)+$20, or $80, for the two units, or at a price of $40 per unit. If participant 24 is only able to sell underlying instrument 114b at $19.50 per unit, participant 24 will attempt to buy two units of underlying instrument 114a at a price of (3×$19.50)+$20, or $78.50, for the two units, or at a price of $39.25 per unit.

In the illustrated example, participant interface 34 receives market information 108 from trading platform 12 that indicates the current contents of queues 120 and 122 or any changes to the contents since participant interface 34 last received market information 108. As described above, participant interface 34 may maintain local copies of queues 120 and 122 that participant interface 34 updates as participant interface 34 receives market information 108 or may use market information 108 as market information 108 is received. Using market information 108 associated with underlying market 104b, participant 24 determines the best price available for the transaction that participant 24 will perform. In this case the relevant price is the best bid price 126 available for underlying instrument 114b. As shown in FIG. 2, the best bid price 126 for which trading platform 12 has received purchase orders 107 in the illustrated example is $20 as reflected by the purchase orders 107a-c in purchase queue 122b. Participant interface 34 may then determine the total quantity of underlying instrument 114b currently being bid at that bid price 124, referred to here as the “total bid quantity.” This total bid quantity comprises an available bid quantity and an unavailable bid quantity.

To determine the available bid quantity, participant interface 34 determines, based on availability indicators 116, which purchase orders 107 in the relevant purchase queue 122, in this case purchase queue 122b, are currently available. Participant interface 34 then sums the purchase quantities specified by the available purchase orders 107 to determine the available bid quantity. In the illustrated example, the available bid quantity comprises the sum of the bid quantities specified by purchase orders 107b and 107c, or 100 units. Additionally, if the corresponding sale queue 120, here sale queue 120b, contains available sale orders 106 that have not been executed, participant interface 34 may, in calculating the available bid quantity, subtract the sum of the offered quantities specified by these available sales orders 106 from the sum of the bid quantities specified by the available purchase orders 107 in purchase queue 122b.

To determine the unavailable bid quantity of the total bid quantity, participant interface 34 identifies, based on availability indicators 116, one or more purchase orders 107 in purchase queue 122b that are currently marked as unavailable. In particular embodiments, purchase queues 122 will only have one purchase order 107 marked as unavailable at a time. In such embodiments, if an unavailable purchase order 107 exists, participant interface 34 determines the unavailable bid quantity by determining the bid quantity specified by the unavailable purchase order 107a, or 140 units. In alternative embodiments, purchase queues 122 may have more than one purchase order 107 simultaneously marked as unavailable. In such embodiments, participant interface 34 determines the unavailable bid quantity by summing the bid quantities specified by all unavailable purchase orders 107 in queue 120b.

After determining the unavailable bid quantity, participant interface 34 determines a portion of the unavailable bid quantity, referred to here as the “temporarily unavailable bid quantity,” that participant 24 anticipates will become available again in the near future. In particular embodiments, an order 106 or 107 is temporarily marked as unavailable while trading platform 12 finalizes trades involving those orders 106 and 107. As a result, in such embodiments, trading platform 12 may identify an unavailable order 106 or 107 associated with the same transaction in the complementary queue 120 or 122 and determine a difference in the quantities specified by the two orders 106 and 107. In particular embodiments, this difference represents the temporarily unavailable bid quantity.

For example, in the illustrated example, participant interface 34 identifies an unavailable sale order 106 in sale queue 120b, unavailable sale order 106d, that is associated with unavailable purchase order 107a. Participant interface 34 may determine the associated unavailable sale order 106 based on its position at the front of the relevant sale queue 120, or based on any appropriate information associating sale order 106d with purchase order 107a or the transaction in which purchase order 107a is currently involved. Participant interface 34 determines the bid quantity specified by sale order 106d, 40 units, and subtracts that quantity from the unavailable bid quantity to determine the temporarily unavailable bid quantity, or 100 units.

Participant interface 34 then determines the virtually available bid quantity for underlying instrument 114b based on the available bid quantity and the temporarily unavailable bid quantity. For example, in particular embodiments, participant interface 34 may determine the virtually available bid quantity by summing the available bid quantity and the temporarily unavailable bid quantity. Furthermore, in particular embodiments, participant 24 may be unable to predict whether all of the temporarily unavailable bid quantity will become available again. As a result, participant 24 may only utilize a portion of the temporarily unavailable bid quantity in calculating the virtually available bid quantity. In particular embodiments, participant 24 may provide a risk factor 134 to participant interface 34 which participant interface 34 uses to scale the temporarily unavailable bid quantity before adding the scaled temporarily unavailable bid quantity to the available bid quantity. In the illustrated example, risk factor 134 equals four-fifths, and so participant interface 34 multiplies the temporarily unavailable bid quantity by four-fifths before adding it to the available bid quantity. This results in a virtually available bid quantity of (100 units×4/5)+100 units, or 180 units.

Participant 24 may then initiate transactions involving underlying instrument 114a and underlying instrument 114b based on this virtually available bid quantity of underlying instrument 114b. Based on the estimate of how much underlying instrument 114b participant 24 can sell at the selected offered price 124 (180 units), participant interface 34 can determine a corresponding quantity of the example spread that can be purchased as a result of the sale of the virtually available bid quantity of underlying instrument 114b. Participant interface 34 may also determine an appropriate amount of underlying instrument 114a to purchase based on the quantity of the example spread that participant 24 can purchase. In particular embodiments, each unit of a requested spread may include a single long position of underlying instrument 114a and a single short position in underlying instrument 114b, and participant 24 may purchase a quantity of underlying instrument 114a equal to the virtual available bid quantity of underlying instrument 114b.

Moreover, in particular embodiments such as the one illustrated in FIG. 2, the requested spread may include an unequal number of each of the relevant underlying instruments 114. Consequently, particular embodiments may utilize one or more trade ratios 132 that specify the quantity of a particular underlying instrument 114 in each unit of the requested spread. For example, in the illustrated example, as noted above, spread order 130 includes trade ratios 132a and 132b representing, respectively, the quantity of underlying instruments 114a and underlying instruments 114b in each unit of the example spread. In particular, trade ratios 132 indicate that each unit of the example spread includes three units of underlying instrument 114a and two units of underlying instrument 114b. As a result, participant interface 34 calculates a quantity of underlying instrument 114a that is three halves the virtually available bid quantity of underlying instrument 114b, or 270 units.

After calculating the appropriate quantities of the relevant underlying instruments 114, participant interface 34 generates appropriate orders 106 and 107 to initiate the calculated transactions. In the illustrated example, participant interface 34 generates a sale order 106e for 180 units of underlying instrument 114b and a purchase order 107g for 270 units of underlying instrument 114a. Participant interface 34 then transmits orders 106e and 107g to trading platform 12. Trading platform 12 then enters the orders 106e and 107g in the appropriate queues 120 or 122 to be executed.

If, before trading platform 12 initiates the trades requested by orders 106 and 107, participant interface 34 receives updated market information 108 that indicates that a better price is now available for underlying instrument 114b, participant interface 34 may repeat calculation of the virtually available bid quantity at the new best bid price 126. For example, if trading platform 12 received a purchase order 107 for underlying instrument 114b specifying a bid price 126 of $20.25, participant interface 34 might repeat a portion or all of the above calculations to determine the virtually available bid quantity of underlying instrument 114b at a bid price of $20.25. Participant interface 34 may then calculate new trade quantities for underlying instrument 114a and underlying instrument 114b based on spread price 136, trade ratios 132, and the new virtually available bid quantity. Participant interface 34 may then cancel previously transmitted orders 106e and 107g, and generate and transmit new orders 106 and 107 based on the newly calculated quantities for underlying instrument 114a and underlying instrument 114b.

Additionally, although FIG. 2 illustrates operation of participant interface 34 in a particular embodiment of trading system 10 that calculates and utilizes the virtually available bid quantity in a particular manner and for a particular purpose, alternative embodiments of participant interface 34 and/or other elements of trading system 10 may utilize the quantity in other manners and to achieve other purposes. As one example, instead of or in addition to utilizing a virtually available bid quantity to calculate a quantity of particular underlying instruments 114 to purchase or sell in a given transaction, particular embodiments of participant interface 34 may utilize the virtually available bid quantity to determine whether or not to initiate or complete the transaction at all. Thus, if the virtually available bid quantity of underlying instrument 114 is insufficient to support the sale of a particular minimum quantity of underlying instrument 114a, participant interface 34 may decide not to initiate any of the transactions associated with the purchase of the requested spread. As another example, participant 24 may represent an entity authorized to issue financial instruments, and participant 24 may issue an instrument whose value is based on the values of the underlying instruments 114 included in a particular spread. As a result, particular embodiments of participant interface 34 may utilize the virtually available bid quantity to calculate an offered price at which to sell the issued instrument. For example, participant interface 34 may calculate a price at which to sell the issued instrument based on the virtually available bid quantity of underlying instrument 104b at a particular price.

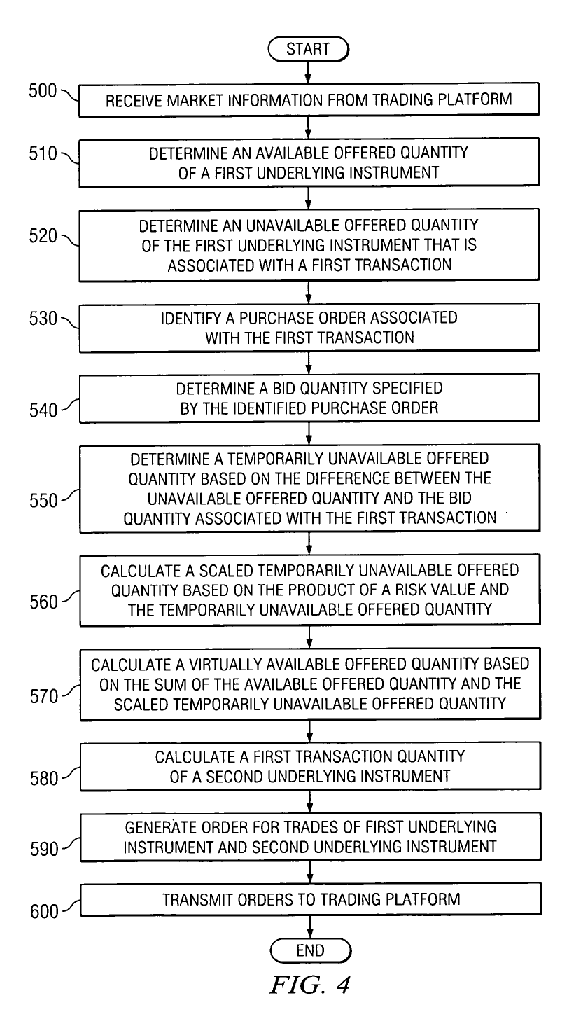

In addition, other elements of trading system 10 may be configured to calculate and/or or utilize virtually available quantities. Furthermore, although the above example focuses on the calculation and use of a virtually available bid quantity to more accurately describe available bid quantities in a given underlying market 104, similar techniques may be utilized in particular embodiments of trading system 10 to calculate and/or use virtually available offered quantities. FIG. 4 below details steps of a particular embodiment of participant interface 34 in implementing similar techniques to determine virtually available offered quantities. Additionally, although FIG. 2 illustrates an example in which participant interface 34 only determines a virtually available quantity of a single of the underlying instruments 114 involved in the example spread, similar techniques may be used to determine the virtually available quantities of additional underlying instruments 114, such as underlying instrument 114a in the illustrated example. Participant interface 34 may then determine an appropriate quantity of the requested spread to purchase based on virtually available quantities of multiple underlying instruments 114.

In general, as a result of the ability of participant interface 34 to determine trade quantities based on virtually available quantities of a given underlying instrument 114, participant 24 may be able to maximize the quantity of the requested spread participant 24 is capable of purchasing at the specified spread price 136. Additionally, by allowing participant 24 to configure risk factor 134, particular embodiments of participant interface 34 provide a flexible technique for determining virtually available quantities that allows participant 24 to choose a risk level with which participant 24 is comfortable. Thus, participant interface 34 may provide multiple operational benefits. Nonetheless, particular embodiments of participant interface 34 (or other elements of trading system 10 implementing these or similar techniques to calculate virtually available quantities) may exhibit some, none, or all of these benefits.

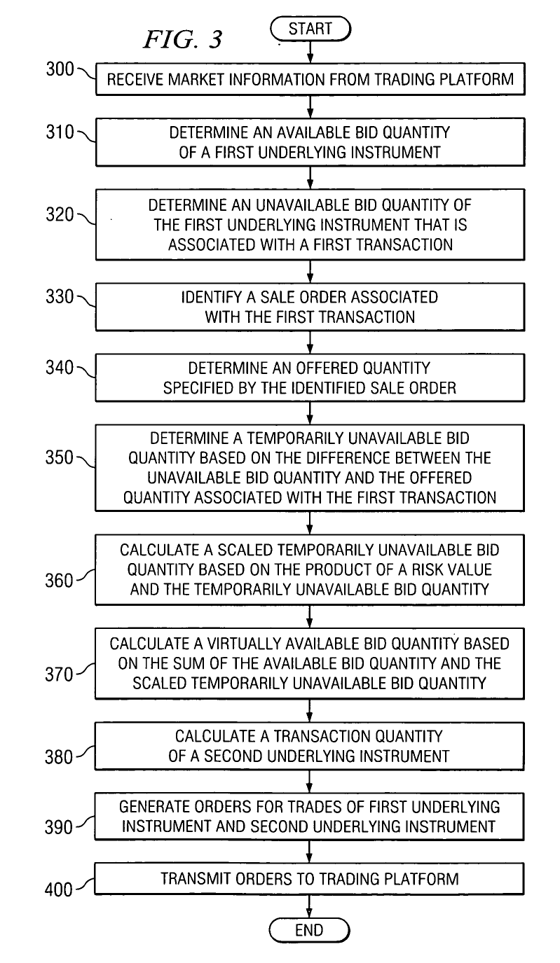

FIG. 3 is a flow chart detailing steps in an example operation of participant interface 34 in generating and utilizing virtually available quantities. In particular, FIG. 3 illustrates example operation of participant interface 34 determining a quantity of a requested spread to purchase based on a virtually available bid quantity of a first underlying instrument 114 at a particular bid price. In the example described by FIG. 3, the requested spread is assumed to include a particular quantity of short positions in a first underlying instrument 114 and a particular quantity of long positions in a second underlying instrument 114.

Operation begins at step 300 with participant interface 34 receiving market information 108 that describes the contents of queues 120 and 122 for underlying instruments 114. At step 310, participant interface 34 determines an available bid quantity of a first underlying instrument 114. The available bid quantity represents an amount of the first underlying instrument 114 requested by purchase orders 107 that have not yet been matched to a received sale order 106.

At step 320, participant interface 34 determines an unavailable bid quantity of the first underlying instrument 114. The unavailable bid quantity comprises an amount of the first underlying instrument 114 associated with a first transaction involving the first underlying instrument 114. In particular embodiments, participant interface 34 determines the unavailable bid quantity by identifying a purchase order 107 in an appropriate purchase queue 122 that has been marked as unavailable and determining a bid quantity specified by the identified purchase order 107.

At step 330, participant interface 34 identifies a sale order 106 associated with the first transaction. As noted above, participant interface 34 may identify the relevant sale order 106 based on its position in the appropriate sale queue 120, information associating it with the unavailable bid quantity in the purchase queue 122, and/or information associating it with the first transaction in any other appropriate manner. At step 340, participant interface 34 determines an offered quantity specified by the identified sale order 106. Using the offered quantity specified by the identified sale order 106, participant interface 34, at step 350, determines a temporarily unavailable bid quantity of the first underlying instrument 114 based, at least in part, on a difference between the unavailable bid quantity and the offered quantity associated with the first transaction.

At step 360, participant interface 34 calculates a scaled temporarily unavailable bid quantity based on the product of a risk value and the temporarily unavailable bid quantity. As noted above, the risk value allows participant 24 to specify a portion of the temporarily unavailable bid quantity that participant 24 would like to consider in making trading decisions based on the temporarily unavailable bid quantity. As a result, the risk value may allow participant 24 to specify an acceptable amount of risk to incur in transactions initiated based on these calculations. At step 370, participant interface 34 calculates the sum of the available bid quantity and the scaled temporarily unavailable bid quantity. This total represents the amount of the first underlying instrument 114a that participant interface 34 will consider as virtually available for the purposes of determining appropriate quantities of the second underlying instrument 114 to buy or sell.

At step 380, participant interface 34 calculates a transaction quantity of the second underlying instrument 114 based on the virtually available bid quantity of the first underlying instrument 114 and trade ratios 132. As noted above, trade ratios 132 describe the composition of the requested spread by each specifying the quantity of a particular underlying instrument 114 that is included in each unit of the requested spread. In the described embodiment, the participant interface 34 determines the transaction quantity by multiplying a trade ratio 132 associated with the second underlying instrument 114 by the quotient of the virtually available bid quantity and a trade ratio 132 associated with the first underlying instrument 114. At step 390, participant interface 34 then generates a sale order 106 to sell the virtually available bid quantity of the first underlying instrument 114 and a purchase order 107 to purchase the transaction quantity of the second underlying instrument 114. At step 400, participant interface 34 transmits the sale order 106 and the purchase order 107 to trading platform 12.

FIG. 4 is a flow chart detailing steps in another example operation of participant interface 34 in generating and utilizing virtually available quantities. In particular, FIG. 4 illustrates example operation of participant interface 34 determining a quantity of a requested spread to purchase based on a virtually available quantity of a first underlying instrument 114 at a particular offered price. In the example described by FIG. 4, each unit of the requested spread is assumed to include a particular quantity of long positions in a first underlying instrument 114 and a particular quantity of short positions in a second underlying instrument 114.

Operation begins at step 500 with participant interface 34 receiving market information 108 that describes the contents of queues 120 and 122 for underlying instruments 114. At step 510, participant interface 34 determines an available offered quantity of a first underlying instrument 114. The available offered quantity represents an amount of the first underlying instrument 114 currently available to be purchased in a market 104 for the first underlying instrument 114.

At step 520, participant interface 34 determines an unavailable offered quantity of the first underlying instrument 114. The unavailable offered quantity comprises an amount of the first underlying instrument 114 associated with a first transaction involving the first underlying instrument 114. In particular embodiments, participant interface 34 determines the unavailable offered quantity by identifying a sale order 106 in an appropriate sale queue 120 that has been marked as unavailable and determining an offered quantity specified by the identified sale order 106.

At step 530, participant interface 34 identifies a purchase order 107 associated with the first transaction. As noted above, participant interface 34 may identify the relevant purchase order 107 based on its position in the appropriate purchase queue 122, information associating it with the unavailable offered quantity in the sale queue 120, and/or information associating it with the first transaction in any other appropriate manner. At step 540, participant interface 34 determines a bid quantity specified by the identified purchase order 107. Using the bid quantity specified by the identified purchase order 107, participant interface 34, at step 550, determines a temporarily unavailable offered quantity of the first underlying instrument 114 based, at least in part, on a difference between the unavailable offered quantity and the bid quantity associated with the first transaction.

At step 560, participant interface 34 calculates a scaled temporarily unavailable offered quantity based on the product of a risk value and the temporarily unavailable offered quantity. As noted above, the risk value allows participant 24 to specify a portion of the temporarily unavailable offered quantity that participant 24 would like to consider in making trading decisions based on the temporarily unavailable offered quantity. As a result, the risk value may allow participant 24 to specify an acceptable amount of risk to incur in transactions initiated based on these calculations. At step 570, participant interface 34 calculates the sum of the available offered quantity and the scaled temporarily unavailable offered quantity. This total represents the amount of the first underlying instrument 114a that participant interface 34 will consider as virtually available for the purposes of determining appropriate quantities of the second underlying instrument 114 to buy or sell.

At step 580, participant interface 34 calculates a transaction quantity of the second underlying instrument 114 based on the virtually available offered quantity of the first underlying instrument 114 and the trade ratios 132. In the described embodiment, the participant interface 34 determines the transaction quantity by multiplying a trade ratio 132 associated with the second underlying instrument 114 by the quotient of the virtually available offered quantity and a trade ratio 132 associated with the first underlying instrument 114. At step 590, participant interface 34 then generates a purchase order 107 to purchase the virtually available offered quantity of the first underlying instrument 114 and a sale order 106 to purchase the transaction quantity of the second underlying instrument 114. At step 600, participant interface 34 transmits the sale order 106 and the purchase order 107 to trading platform 12.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for conducting transactions of traded instruments, comprising:
determining an available offered quantity of a first instrument, the available offered quantity of the first instrument comprising an amount of the first instrument currently available to be purchased in a market for the first instrument;
determining an unavailable offered quantity of the first instrument, the unavailable offered quantity comprising an amount of the first instrument specified by a sale order associated with a first transaction involving the first instrument;
determining a bid quantity specified by a purchase order associated with the first transaction;
calculating a temporarily unavailable offered quantity of the first instrument based, at least in part, on a difference between the unavailable offered quantity of the first instrument and the bid quantity associated with the first transaction; and
calculating a quantity of a second instrument associated with a second transaction based, at least in part, on a sum of the available offered quantity of the first instrument and at least a portion of the temporarily unavailable offered quantity of the first instrument.

2. The method of claim 1, further comprising initiating the second transaction.

3. The method of claim 1, wherein calculating the quantity of the second instrument comprises deciding not to initiate the second transaction based on the sum.

4. The method of claim 1, further comprising initiating a third transaction involving the available offered quantity of the first instrument and at least a portion of the temporarily unavailable offered quantity of the first instrument.

5. The method of claim 1, wherein calculating the quantity of the second instrument comprises:
calculating a scaled temporarily unavailable offered quantity of the first instrument based on a product of the temporarily unavailable offered quantity of the first instrument and a risk value; and
calculating the quantity of the second instrument associated with the second transaction based, at least in part, on a sum of the available offered quantity of the first instrument and the scaled temporarily unavailable offered quantity of the first instrument.

6. The method of claim 1, further comprising offering a third instrument for sale, wherein a value of the third instrument is based, at least in part, on a value of a position in the first instrument and a value of a position in the second instrument.

7. The method of claim 6, wherein
determining an available offered quantity of the first instrument comprises determining an amount of the first instrument currently available to be purchased at a first price;
calculating a quantity of the second instrument associated with a second transaction comprises calculating a quantity of the second instrument associated with a second transaction to be executed at a second price; and
offering the third instrument for sale comprises calculating a third price based at least in part on the first price and the second price and offering the third instrument for sale at the third price.

8. A method for initiating transactions of traded instruments, comprising:
determining an available bid quantity of a first instrument, the available bid quantity of the first instrument comprising an amount of the first instrument currently bid upon in a market for the first instrument;
determining an unavailable bid quantity of the first instrument, the unavailable bid quantity of the first instrument comprising an amount of the first instrument specified by a purchase order associated with a first transaction involving the first instrument;
determining an offered quantity associated with the first transaction;
calculating a temporarily unavailable bid quantity of the first instrument based, at least in part, on a difference between the unavailable bid quantity of the first instrument and the offered quantity associated with the first transaction; and
calculating a quantity of a second instrument associated with a second transaction based, at least in part, on a sum of the available bid quantity of the first instrument and at least a portion of the temporarily unavailable bid quantity of the first instrument.

9. The method of claim 8, further comprising initiating the second transaction.

10. The method of claim 8, wherein calculating the quantity of the second instrument comprises deciding not to initiate the second transaction based on the sum.

11. The method of claim 8, further comprising initiating a third transaction involving the available bid quantity of the first instrument and at least a portion of the temporarily unavailable bid quantity of the first instrument.

12. The method of claim 8, wherein calculating the quantity of the second instrument comprises:
calculating a scaled temporarily unavailable bid quantity of the first instrument based on a product of the temporarily unavailable bid quantity of the first instrument and a risk value; and
calculating the quantity of the second instrument associated with the second transaction based, at least in part, on a sum of the available bid quantity of the first instrument and the scaled temporarily unavailable bid quantity of the first instrument.

13. The method of claim 8, further comprising offering a third instrument for sale, wherein a value of the third instrument is based, at least in part, on a value of a position in the first instrument and a value of a position in the second instrument.

14. The method of claim 13, wherein
determining an available bid quantity of the first instrument comprises determining an amount of the first instrument currently bid upon at a first price in the market;
calculating a quantity of the second instrument associated with a second transaction comprises calculating a quantity of the second instrument associated with a second transaction to be executed at a second price; and
offering the third instrument for sale comprises calculating a third price based at least in part on the first price and the second price and offering the third instrument for sale at the third price.

15. A trading system, comprising:
a trading platform operable to execute sale orders and purchase orders; and
a plurality of interfaces operable to transmit sale orders and purchase orders to the trading platform, wherein at least one of the plurality of interfaces is operable to:
determine an available offered quantity of a first instrument, the available offered quantity of the first instrument comprising an amount of the first instrument currently available to be purchased in a market for the first instrument;
determine an unavailable offered quantity of the first instrument, the unavailable offered quantity of the first instrument comprising an amount of the first instrument specified by a sale order associated with a first transaction involving the first instrument;
determine a bid quantity specified by a purchase order associated with the first transaction;
calculate a temporarily unavailable offered quantity of the first instrument based, at least in part, on a difference between the unavailable offered quantity of the first instrument and the bid quantity associated with the first transaction; and
calculate a quantity of a second instrument associated with a second transaction based, at least in part, on a sum of the available offered quantity of the first instrument and at least a portion of the temporarily unavailable offered quantity of the first instrument.

16. The system of claim 15, wherein the at least one interface is further operable to transmit to the trading platform an order specifying the quantity of the second instrument associated with the second transaction.

17. The system of claim 15, wherein the at least one interface is operable to calculate the quantity of the second instrument by deciding not to initiate the second transaction based on the sum.

18. The system of claim 15, wherein the at least one interface is operable to transmit a purchase order to the trading platform, the purchase order specifying a purchase quantity that includes the available offered quantity of the first instrument and at least a portion of the temporarily unavailable offered quantity of the first instrument.

19. The system of claim 15, wherein the at least one interface is operable to calculate the quantity of the second instrument by:
calculating a scaled temporarily unavailable offered quantity of the first instrument based on a product of the temporarily unavailable offered quantity of the first instrument and a risk value; and
calculating the quantity of the second instrument associated with the second transaction based, at least in part, on a sum of the available offered quantity of the first instrument and the scaled temporarily unavailable offered quantity of the first instrument.

20. The system of claim 15, wherein the at least one interface is further operable to transmit a sale order specifying a third instrument for sale, wherein a value of the third instrument is based, at least in part, on a value of a position in the first instrument and a value of a position in the second instrument.

21. The system of claim 20, wherein the at least one interface is operable to:
determine an available offered quantity of the first instrument by determining an amount of the first instrument currently available to be purchased at a first price;
calculate a quantity of the second instrument associated with a second transaction by calculating a quantity of the second instrument associated with a second transaction to be executed at a second price; and
transmit the sale order specifying the third instrument by:
calculating a third price based, at least in part, on the first price and the second price; and
transmitting to the trading platform a sale order that specifies the third price as a sale price for the third instrument.

22. A trading system, comprising:
a trading platform operable to execute sale orders and purchase orders; and
a plurality of interfaces operable to transmit sale orders and purchase orders to the trading platform, wherein at least one of the plurality of interfaces is operable to:
determine an available bid quantity of a first instrument, the available offered quantity of the first instrument comprising an amount of the first instrument currently bid upon in a market for the first instrument;
determine an unavailable bid quantity of the first instrument, the unavailable bid quantity of the first instrument comprising an amount of the first instrument specified by a purchase order associated with a first transaction involving the first instrument;
determine an offered quantity associated with the first transaction;
calculate a temporarily unavailable bid quantity of the first instrument based, at least in part, on a difference between the unavailable bid quantity of the first instrument and the offered quantity associated with the first transaction; and
calculate a quantity of a second instrument associated with a second transaction based, at least in part, on a sum of the available bid quantity of the first instrument and at least a portion of the temporarily unavailable bid quantity of the first instrument.

23. The system of claim 22, wherein the at least one interface is further operable to transmit to the trading platform an order specifying the quantity of the second instrument associated with the second transaction.

24. The system of claim 22, wherein the at least one interface is operable to calculate the quantity of the second instrument by deciding not to initiate the second transaction based on the sum.

25. The system of claim 22, wherein the at least one interface is operable to transmit a purchase order to the trading platform, the purchase order specifying a bid quantity that includes the available bid quantity of the first instrument and at least a portion of the temporarily unavailable bid quantity of the first instrument.

26. The system of claim 22, wherein the at least one interface is operable to calculate the quantity of the second instrument by:
calculating a scaled temporarily unavailable bid quantity of the first instrument based on a product of the temporarily unavailable bid quantity of the first instrument and a risk value; and
calculating the quantity of the second instrument associated with the second transaction based, at least in part, on a sum of the available bid quantity of the first instrument and the scaled temporarily unavailable bid quantity of the first instrument.

27. The system of claim 22, wherein the at least one interface is further operable to transmit a sale order specifying a third instrument for sale, wherein a value of the third instrument is based, at least in part, on a value of a position in the first instrument and a value of a position in the second instrument.

28. The system of claim 27, wherein the at least one interface is operable to:
determine an available bid quantity of the first instrument by determining an amount of the first instrument currently bid upon at a first price in the market;
calculate a quantity of the second instrument associated with a second transaction by calculating a quantity of the second instrument associated with a second transaction to be executed at a second price; and
transmit the sale order specifying the third instrument by:
calculating a third price based, at least in part, on the first price and the second price; and
transmitting to the trading platform a sale order that specifies the third price as a sale price for the third instrument.

29. A trading interface, comprising:
a memory operable to store processor instructions; and
a processor operable to:
determine an available offered quantity of a first instrument, the available offered quantity of the first instrument comprising an amount of the first instrument currently available to be purchased in a market for the first instrument;
determine an unavailable offered quantity of the first instrument, the unavailable offered quantity of the first instrument comprising an amount of the first instrument specified by a sale order associated with a first transaction involving the first instrument;
determine a bid quantity specified by a purchase order associated with the first transaction;
calculate a temporarily unavailable offered quantity of the first instrument based, at least in part, on a difference between the unavailable offered quantity of the first instrument and the bid quantity associated with the first transaction; and
calculate a quantity of a second instrument associated with a second transaction based, at least in part, on a sum of the available offered quantity of the first instrument and at least a portion of the temporarily unavailable offered quantity of the first instrument.

30. The trading interface of claim 29, wherein the trading interface is further operable to initiate the second transaction.

31. The trading interface of claim 29, wherein the trading interface is operable to calculate the quantity of the second instrument by deciding not to initiate the second transaction based on the sum.

32. The trading interface of claim 29, wherein the trading interface is operable to initiate a third transaction involving the available offered quantity of the first instrument and at least a portion of the temporarily unavailable offered quantity of the first instrument.

33. The trading interface of claim 29, wherein the trading interface is operable to calculate the quantity of the second instrument by:
calculating a scaled temporarily unavailable offered quantity of the first instrument based on a product of the temporarily unavailable offered quantity of the first instrument and a risk value; and
calculating the quantity of the second instrument associated with the second transaction based, at least in part, on a sum of the available offered quantity of the first instrument and the scaled temporarily unavailable offered quantity of the first instrument.

34. The trading interface of claim 29, wherein the trading interface is further operable to generate a sale order identifying a third instrument for sale, wherein a value of the third instrument is based, at least in part, on a value of a position in the first instrument and a value of a position in the second instrument.

35. The trading interface of claim 34, wherein the trading interface is operable to:
determine an available offered quantity of the first instrument by determining an amount of the first instrument currently available to be purchased at a first price;
calculate a quantity of the second instrument associated with a second transaction by calculating a quantity of the second instrument associated with a second transaction to be executed at a second price; and
generate the sale order identifying the third instrument by:
calculating a third price based, at least in part, on the first price and the second price; and
generate a sale order that specifies the third price as a sale price for the third instrument.

36. A trading interface, comprising:
a trading platform operable to execute sale orders and purchase orders; and
a plurality of interfaces operable to transmit sale orders and purchase orders to the trading platform, wherein at least one of the plurality of interfaces is operable to:
determine an available bid quantity of a first instrument, the available offered quantity of the first instrument comprising an amount of the first instrument currently bid upon in a market for the first instrument;
determine an unavailable bid quantity of the first instrument, the unavailable bid quantity of the first instrument comprising an amount of the first instrument specified by a purchase order associated with a first transaction involving the first instrument;
determine an offered quantity associated with the first transaction;
calculate a temporarily unavailable bid quantity of the first instrument based, at least in part, on a difference between the unavailable bid quantity of the first instrument and the offered quantity associated with the first transaction; and
calculate a quantity of a second instrument associated with a second transaction based, at least in part, on a sum of the available bid quantity of the first instrument and at least a portion of the temporarily unavailable bid quantity of the first instrument.

37. The trading interface of claim 36, wherein the trading interface is further operable to initiate the second transaction.

38. The trading interface of claim 36, wherein the trading interface is operable to calculate the quantity of the second instrument by deciding not to initiate the second transaction based on the sum.

39. The trading interface of claim 36, wherein the trading interface is operable to initiate a third transaction involving the available bid quantity of the first instrument and at least a portion of the temporarily unavailable bid quantity of the first instrument.

40. The trading interface of claim 36, wherein the trading interface is operable to calculate the quantity of the second instrument by:
calculating a scaled temporarily unavailable bid quantity of the first instrument based on a product of the temporarily unavailable bid quantity of the first instrument and a risk value; and
calculating the quantity of the second instrument associated with the second transaction based, at least in part, on a sum of the available bid quantity of the first instrument and the scaled temporarily unavailable bid quantity of the first instrument.

41. The trading interface of claim 36, wherein the trading interface is further operable to generate a sale order identifying a third instrument for sale, wherein a value of the third instrument is based, at least in part, on a value of a position in the first instrument and a value of a position in the second instrument.

42. The trading interface of claim 41, wherein the trading interface is operable to:
determine an available bid quantity of the first instrument by determining an amount of the first instrument currently bid upon at a first price in the market;
calculate a quantity of the second instrument associated with a second transaction by calculating a quantity of the second instrument associated with a second transaction to be executed at a second price; and
generate the sale order identifying the third instrument by:
calculating a third price based, at least in part, on the first price and the second price; and
generate a sale order that specifies the third price as a sale price for the third instrument.

43. A method of trading, comprising:
determining an available quantity of a first instrument;
determining a first transaction quantity of the first instrument based on a first order associated with a first transaction involving the first instrument;
determining a second transaction quantity of the first instrument based on a second order associated with the first transaction;
calculating a temporarily unavailable quantity of the first instrument based, at least in part, on a difference between the first transaction quantity and the second transaction quantity; and
calculating a quantity of a second instrument associated with a second transaction based, at least in part, on a sum of the available offered quantity of the first instrument and at least a portion of the temporarily unavailable offered quantity of the first instrument.
